(19) United States
(12) Patent Application Publication
(10) Pub. No.: US 2013/0069495 A1
(43) Pub. Date: Mar. 21, 2013

(54) SWITCHED RELUCTANCE MOTOR

(71) Applicant: Jae Woo Jun, Gyunggi-do (KR)

(72) Inventor: Jae Woo Jun, Gyunggi-do (KR)

(73) Assignee: SAMSUNG ELECTRO-MECHANICS CO., LTD., Gyunggi-do (KR)

(21) Appl. No.: 13/351,076

(22) Filed: Jan. 16, 2012

(30) Foreign Application Priority Data
Sep. 15, 2011 (KR) 1020110093063

(51) Int. Cl. H02K 11/00

(52) U.S. Cl. 310/68 R

(57) ABSTRACT

Disclosed herein is a switched reluctance motor including: a bracket made of a magnetic material; a circuit board mounted on an upper portion of the bracket and including various electronic circuits mounted thereon, the electronic circuits applying electric force; a stator assembly mounted on an upper portion of the circuit board and including a plurality of salient poles formed in a radial direction, the salient poles including coils wound therearound; and a rotor case including protrusion parts and groove parts formed at a side thereof, coupled to an outer diameter of the stator assembly and rotating by electromagnetic force generated in the stator assembly when power is applied to the coils.

### CROSS REFERENCE TO RELATED APPLICATION

This application claims the benefit of Korean Patent Application No. 10-2011-0093063, filed on Sep. 15, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a general switched reluctance motor (SRM), both of a stator and a rotor have a salient pole type magnetic structure.

In addition, the stator has a concentrated type coil wound therearound, and the rotor is configured only of an iron core without any type of excitation device (a winding, a permanent magnet, or the like), such that a competitive cost is excellent. Further, a speed changeable switched reluctance motor stably generates a continuous torque with the aid of a converter using a power semiconductor and a position sensor and is easily controlled to be appropriate for performance required in each application.

In addition, the switched reluctance motor is inexpensive due to a simple structure of the rotor; however, it has disadvantages in that a converter formed of a semiconductor switch should be used in order to generate a reluctance torque, a cost of the entire system increases, and an expensive control circuit capable of performing high speed calculation should be included in order to perform an appropriate control at the time of high speed driving.

Further, a universal motor that is mainly used in a field such as a cleaner, an electric power tool, or the like, generates a torque without a converter and a position sensor through the use of a commutator and a brush, which is a simple mechanical structure. The universal motor has widely been used in the field such as a cleaner, an electric power tool, or the like, due to an advantage in which it has a low cost structure rather than improvement in performance by a control. However, a coil is wound around a rotor as well as a stator, such that a material cost increases and copper loss of the rotor occurs, thereby reducing efficiency of the motor. Therefore, it is difficult to apply the universal motor to a high level model requiring high efficiency.

In an out rotor type motor among the switched reluctance motors according to the prior art, a magnet is attached to a rotor, such that the rotor rotates by electromagnetic interaction between the magnet and a stator assembly at the center fixing side.

That is, the out rotor type motor obtains rotational force by electromagnetic force of the stator assembly and magnetic force of the magnet. More specifically, the stator assembly is fixed and is assembled with a rotor case, which is a rotation body of the magnet, and the rotor case rotates by interaction of magnetic force.

However, a cost of the magnet continuously rises due to restriction on the use of the magnet in China. Therefore, research into a structure that does not include the magnet against depletion of resources in the future has been urgently demanded.

### SUMMARY OF THE INVENTION

The present invention has been made in an effort to provide a switched reluctance motor that does not include a magnet in order to reduce a cost.

According to a preferred embodiment of the present invention, there is provided a switched reluctance motor including: a bracket made of a magnetic material; a circuit board mounted on an upper portion of the bracket and including various electronic circuits mounted thereon, the electronic circuits applying electric force; a stator assembly mounted on an upper portion of the circuit board and including a plurality of salient poles formed in a radial direction, the salient poles including coils wound therearound; and a rotor case including protrusion parts and groove parts formed at a side thereof, coupled to an outer diameter of the stator assembly and rotating by electromagnetic force generated in the stator assembly when power is applied to the coils.

The number of salient poles of the stator assembly may be 12.

The salient poles of the stator assembly may have a 3-phase structure.

The salient poles of the stator assembly may have a 3n-phase structure in which u, v, and w poles are sequentially formed.

The number of protrusion parts of the rotor case may be 8.

The rotor case may be made of a magnetic material.

The rotor case may rotate by electromagnetic force generated at a position of the v pole of the salient pole of the stator assembly when the power is applied only to the v pole.

The rotor case may rotate by electromagnetic force generated at a position of the u pole of the salient pole of the stator assembly when the power is applied only to the u pole.

The rotor case may rotate by electromagnetic force generated at a position of the w pole of the salient pole of the stator assembly when the power is applied only to the w pole.

The switched reluctance motor may further include a chuck assembly mounted on an upper portion of the rotor case.

### BRIEF DESCRIPTION OF THE DRAWINGS

FIG. 1 is an exploded perspective view of a switched reluctance motor according to a preferred embodiment of the present invention;

FIG. 2 is a cross-sectional view of the switched reluctance motor according to the preferred embodiment of the present invention; and

FIGS. 3 to 6 are cross-sectional views of a rotor case according to a current application point of the switched reluctance motor according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

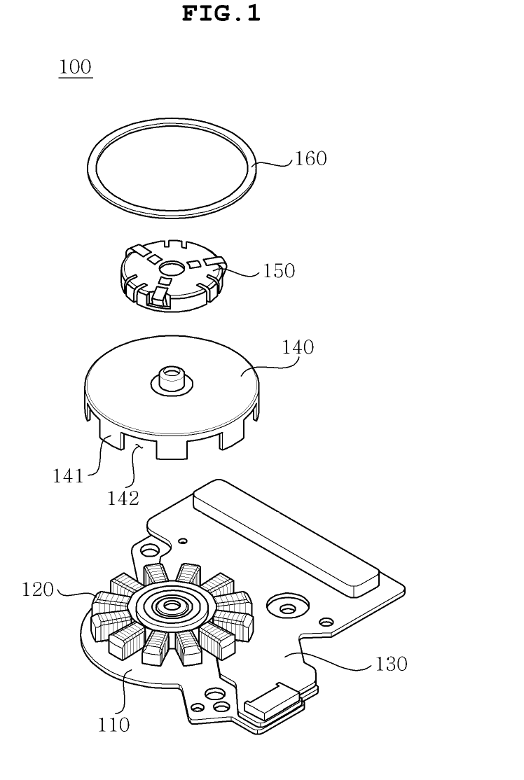

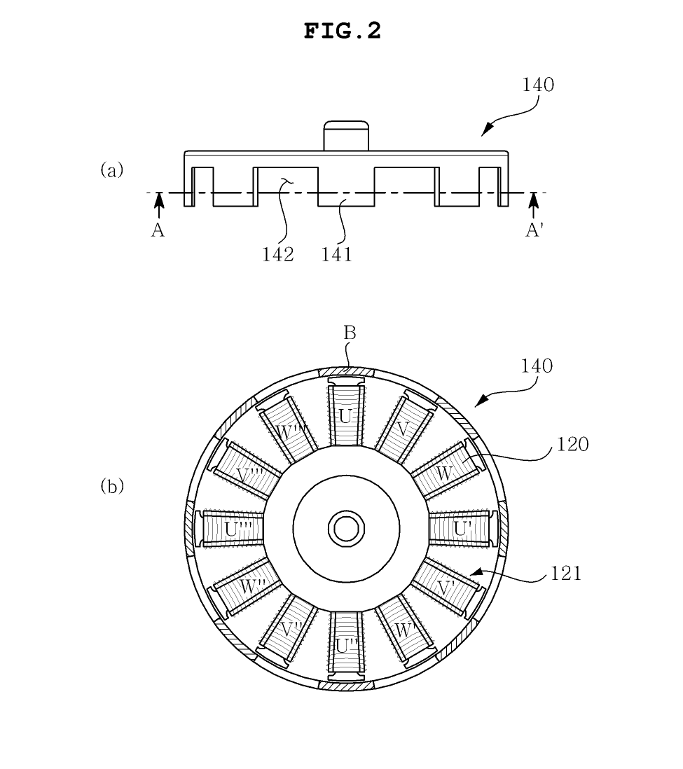

FIG. 1 is an exploded perspective view of a switched reluctance motor according to a preferred embodiment of the present invention; and FIG. 2 is a cross-sectional view of the switched reluctance motor according to the preferred embodiment of the present invention.

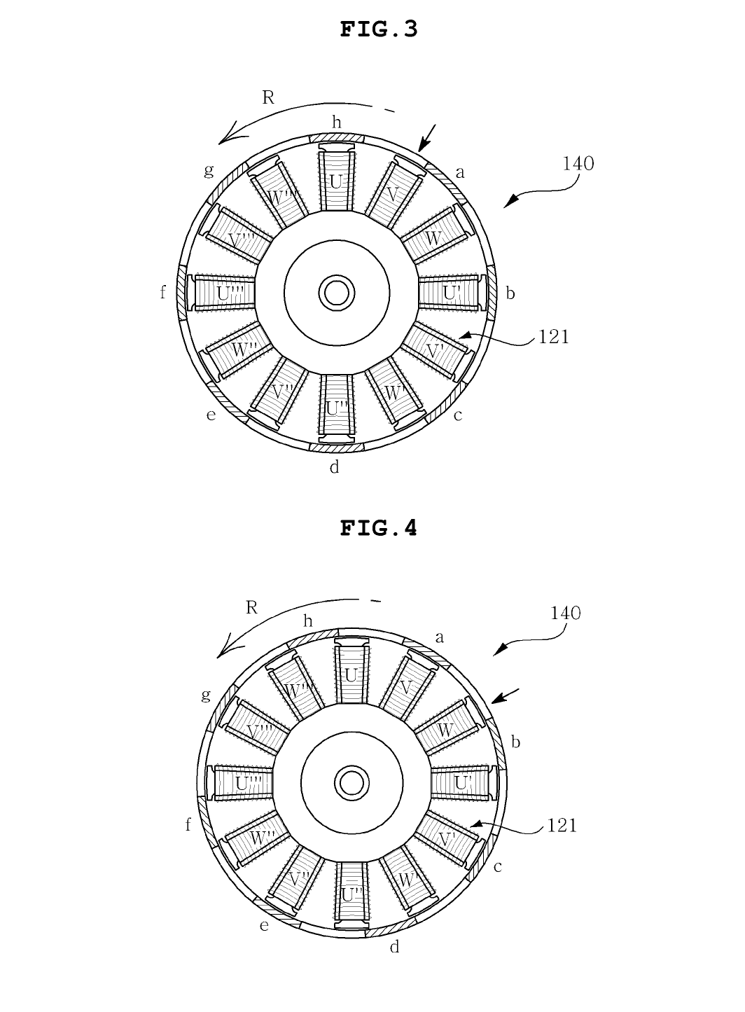

FIGS. 3 to 6 are cross-sectional views of a rotor case according to a current application point of the switched reluctance motor according to the preferred embodiment of the present invention.

As shown in FIG. 1, the switched reluctance motor 100 according to the preferred embodiment of the present invention, which is an outer rotor type motor, is configured to include a bracket 110, a stator assembly 120, a circuit board 130, a rotor case 140, a chuck assembly 150, and a rubber 160.

The bracket 110 generally supports a lower portion of the motor and is made of a magnetic material.

The stator assembly 120 is mounted on an upper portion of the bracket 110 and includes a plurality of salient poles. The number of salient poles may be various, the salient poles include coils wound therearound and are sequentially formed of u, v, and w poles, and current is sequentially applied to each pole. A specific content for the salient poles and current application will be described in more detail below with reference to the accompanying drawings.

The circuit board 130 is mounted between the bracket 110 and the stator assembly 120 and includes various electronic elements and electric circuits in order to apply electric force.

The circuit board 130 is mounted with control elements for applying driving signal to the coil of the stator assembly 120, and is supported by a cylindrical support part (not shown) extended from the bracket 110 mounted thereunder, having a space from a bottom. The control elements mounted on a lower surface of the circuit board 130 are positioned in this space.

The rotor case 140 is mounted over the stator assembly 120 and includes a rotary plate and protrusion parts 141 and groove parts 142 formed at equidistance at an outer diameter of the rotary plate in an axial direction.

The rotor case 140 includes a shaft 143 mounted on an upper portion thereof and supports rotation of the motor.

The protrusion parts 141 of the rotor case 140 are disposed between the salient poles of the stator assembly 120. The relationship between a shape of the stator assembly 120 and disposition of the salient poles will be described in more detail below with reference to the accompanying drawings.

The chuck assembly 150 is mounted on an upper portion of the rotor case 140 and includes the shaft 143 mounted therein to thereby support rotation of the rotor case 140 at the upper portion of the rotor case 140.

The rubber 160 is mounted on an outer diameter of the rotor case 140 to thereby prevent friction between the rotor case and other components and is generally made of an elastic material. The rubber 160 has a ring shape so as to be easily mounted on the outer diameter of the rotor case 140.

FIGS. 2A and 2B show the rotor case 140 of the switched reluctance motor 100 according to the preferred embodiment of the present invention and a cross section of the rotor case 140 taken along line A-A, respectively.

The rotor case 140 is formed by stacking magnetic steel plates and is rotatably disposed outside the stator assembly 120 to be spaced apart from the stator assembly 120 by a predetermined gap.

FIG. 2A shows a side of the rotor case 140. At the side of the rotor case 140, the protrusion parts 141 and the groove parts 142 are sequentially formed.

FIG. 2B shows a cross section of the rotor case 140 taken along the line A-A. The rotor case 140 is mounted on an outer diameter of the stator assembly 120. In this configuration, the protrusion part 141 of the rotor case 140 is disposed at a portion B.

As shown in FIG. 2B, the portion B at which the protrusion part 141 of the rotor case 140 is formed at an outer peripheral surface of the salient pole of the stator assembly 120 and an outer peripheral surface between the salient poles.

Twelve salient poles of the stator assembly 120 of the motor 100 according to the preferred embodiment of the present invention are formed in a radial direction based on the shaft 143.

The salient poles of the stator assembly 120 include the coils 121 wound therearound, and current flowing in the coils 121 flows in an opposite direction to a direction in which current flows in coils adjacent to the coils 121.

When power is applied to the motor, the rotor case 140 rotates. Here, when the power is applied to one of the coils 121 of the stator assembly 120, a position part of the rotor case 140 rotates in a rotation progress direction due to magnetic force.

Therefore, since the SRM motor among the out rotor type SRM motors may rotate without using a separate magnet, a material cost may be significantly reduced.

FIGS. 3 to 6 show rotation of the rotor case 140 of the switched reluctance motor 100 according to the preferred embodiment of the present invention in detail.

In FIG. 3, u, v, and w poles are sequentially expressed in twelve salient poles of the stator assembly 120. When power is applied only to coils 121 wound at v, v′, v″, and v′″ positions among the twelve salient poles, electromagnetic force is generated in the stator assembly 120 of the v, v′, v″, and v′″ positions, and a, c, e, and g position parts of the rotor case 140 made of metals attached to a magnet rotate in an arrow direction R due to magnetic force.

Therefore, since the rotor case 140 may rotate by applying the power to some coils 121 wound around the salient poles, a separate magnet for rotation is not required.

In FIG. 4, u, v, and w poles are sequentially expressed in twelve salient poles of the stator assembly 120. The power applied to the coils 121 wound at the v, v′, v″, and v′″ positions turns off at an optimal point in the vicinity of the center position between the rotating a, c, e, and g position parts of the rotor case 140 and the v, v′, v″, and v′″ positions of the stator assembly 120. Then, when the power is applied only to coils 121 wound at w, w′, w″, and w′″ positions, b, d, f, and h positions parts of the rotor case 140 rotates in the rotation progress direction R due to magnetic force.

Therefore, since the rotor case 140 may rotate by applying the power to some coils 121 wound around the salient poles, a separate magnet for rotation is not required.

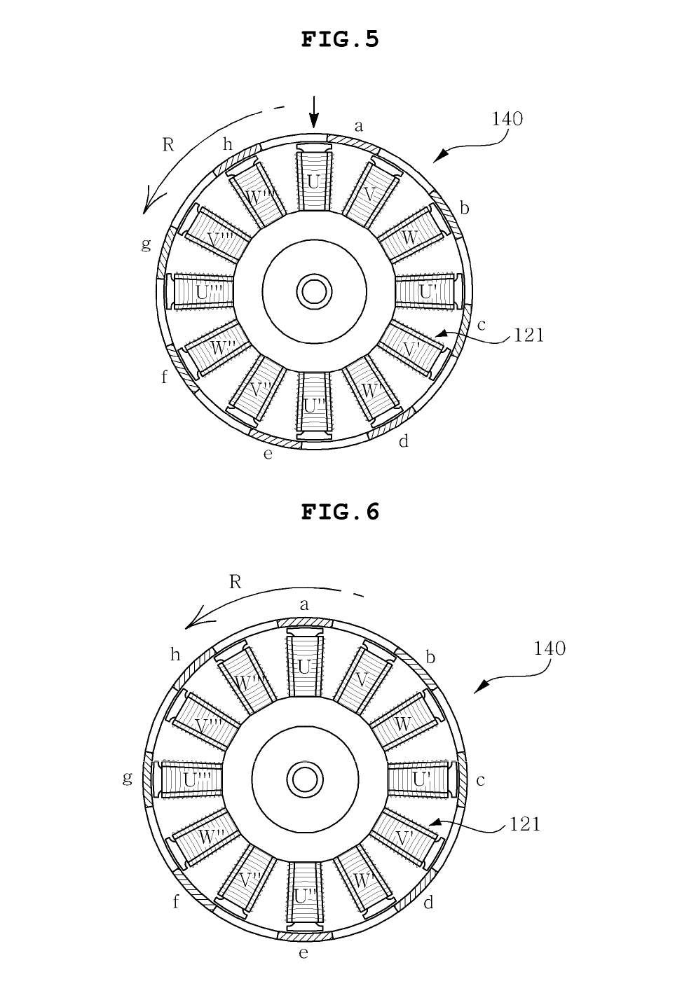

In FIG. 5, when the power applied to the coils 121 wound at the w, w′, w″, and w′″ positions turns off at an optimal point in the vicinity of the center position between the rotating b, d, f, and h position parts of the rotor case 140 and the w, w′, w″, and w′″ positions of the stator assembly 120 and is applied only to coils 121 wound at u, u′, u″, and u′″ positions, the a, c, e, and g position parts of the rotor case 140 rotates in the rotation direction R due to magnetic force.

In FIG. 6, when the power applied to the coils 121 wound at the u, u′, u″, and u′″ positions turns off at an optimal point in the vicinity of the center position between the rotating a, c, e, and g position parts of the rotor case 140 and the u, u′, u″, and u′″ positions of the stator assembly 120 and is applied only to the coils 121 wound at v, v′, v″, and v′″ positions, the b, d, f, and h position parts of the rotor case 140 rotates in the rotation direction R due to magnetic force.

As described above, when the power is sequentially applied to the coils 121 of the stator assembly 120, the rotor case 140 continuously obtains rotational force to thereby rotate. A description for a method of sensing a position and applying voltage to the coil 121 will be omitted in the present specification.

Therefore, the switched reluctance motor 100 having the above-mentioned structure includes the rotor case 140 provided with the protrusion parts 141 and the groove parts 142 and mounted on the outer diameter of the stator assembly 120, without using the magnet. Since the rotor case 140 rotates by sequentially applying current to the coils 121 of the stator assembly 120, a separate magnet for rotation is not required.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a bracket made of a magnetic material;
a circuit board mounted on an upper portion of the bracket and including various electronic circuits mounted thereon, the electronic circuits applying electric force;
a stator assembly mounted on an upper portion of the circuit board and including a plurality of salient poles formed in a radial direction, the salient poles including coils wound therearound; and
a rotor case including a rotary plate and protrusion parts and groove parts formed at equidistance at an outer diameter of the rotary plate in an axial direction to thereby be coupled to an outer diameter of the stator assembly and rotating by electromagnetic force generated in the stator assembly when power is applied to the coils.

2. The switched reluctance motor as set forth in clam 1, wherein the number of salient poles of the stator assembly is 12.

3. The switched reluctance motor as set forth in clam 1, wherein the salient poles of the stator assembly have a 3-phase structure.

4. The switched reluctance motor as set forth in clam 3, wherein the salient poles of the stator assembly have a 3n-phase structure in which u, v, and w poles are sequentially formed.

5. The switched reluctance motor as set forth in clam 1, wherein the number of protrusion parts of the rotor case is 8.

6. The switched reluctance motor as set forth in clam 1, wherein the rotor case is made of a magnetic material.

7. The switched reluctance motor as set forth in clam 4, wherein the rotor case rotates by electromagnetic force generated at a position of the v pole of the salient pole of the stator assembly when the power is applied only to the v pole.

8. The switched reluctance motor as set forth in clam 4, wherein the rotor case rotates by electromagnetic force generated at a position of the u pole of the salient pole of the stator assembly when the power is applied only to the u pole.

9. The switched reluctance motor as set forth in clam 4, wherein the rotor case rotates by electromagnetic force generated at a position of the w pole of the salient pole of the stator assembly when the power is applied only to the w pole.

10. The switched reluctance motor as set forth in clam 1, further comprising a chuck assembly mounted on an upper portion of the rotor case.
